(19) United States
(12) Patent Application Publication
(10) Pub. No.: US 2010/0321447 A1
(43) Pub. Date: Dec. 23, 2010

(54) PROTECTIVE LAYERS FOR MICRO-FLUID EJECTION DEVICES AND METHODS FOR DEPOSITING SAME

(76) Inventors: Robert Wilson Cornell, Lexington, KY (US); Yimin Guan, Lexington, KY (US); Burton Lee Joyner, II, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/851,774

(22) Filed: Aug. 6, 2010

Related U.S. Application Data
(63) Continuation of application No. 11/427,549, filed on Jun. 29, 2006, now abandoned.

(51) Int. Cl. B41J 2/05; H05B 3/02

(52) U.S. Cl. 347/64; 219/201

(57) ABSTRACT

Heater chips for a micro-fluid ejection device, such as those having a reduced energy requirement and more efficient production process therefor. One such heater chip includes a resistive layer deposited adjacent to a substrate and a protective layer deposited adjacent to the resistive layer. The protective layer can be a tantalum oxide protective layer, which has a high breakdown voltage. An optional cavitation layer of tantalum, which bonds well with the tantalum oxide layer, may be deposited adjacent to the protective layer. Alternatively, for example, the tantalum oxide layer may serve as both the protective layer and the cavitation layer.

This application claims priority and benefit as a continuation application of U.S. patent Ser. No. 11/427,549, filed Jun. 29, 2006.

### TECHNICAL FIELD

The disclosure relates to micro-fluid ejection devices and, in particular, in one exemplary embodiment, to improved protective layers and methods for making the improved protective layers for heater resistors used in micro-fluid ejection devices.

### BACKGROUND AND SUMMARY

In the production of thermal micro-fluid ejection devices such as ink jet printheads, a cavitation layer is typically provided as an ink contact layer for a heater resistor. The cavitation layer prevents damage to the underlying dielectric (protective) and resistive layers during ink ejection. Between the cavitation layer and heater resistor there are typically one or more layers of a passivation material to reduce ink corrosion of the heater resistor. As ink is heated in an ink chamber by the heater resistor, a bubble forms and forces ink out of the ink chamber and through an ink ejection orifice. After the ink is ejected, the bubble collapses causing mechanical shock to the thin metal layers comprising the ink ejection device. In a typical printhead, tantalum (Ta) is used as a cavitation layer. The Ta layer is deposited on a dielectric layer such as silicon carbide (SiC) or a composite layer of SiC and silicon nitride (SiN). In the composite layer, SiC is adjacent to the Ta layer.

One disadvantage of the multilayer thin film heater construction is that the cavitation and protective layers are less heat conductive than the underlying resistive layer. Accordingly, such construction increases the energy requirements a micro-fluid ejection head constructed using such protective layers. Increased energy input to the heater resistors not only increases the overall ejection head temperature, but also reduces the frequency of drop ejection thereby decreasing the speed of operation of the ejection device. Hence, there continues to be a need for micro-fluid ejection heads having lower energy consumption and methods for producing such ejection heads.

With regard to the above, one embodiment of the disclosure provides a micro-fluid ejection device having a heater chip with a resistive layer deposited adjacent to a substrate and a protective layer deposited adjacent to the resistive layer, wherein the protective layer is a sputter deposited tantalum oxide layer.

In another embodiment, the disclosure provides a method for making a heater chip for a micro-fluid ejection device including depositing a resistive layer and depositing a protective layer. The resistive layer is deposited adjacent to a substrate. The protective layer is tantalum pentoxide and is deposited adjacent to at least a portion of the resistive layer.

In yet another embodiment, the disclosure provides a heater chip for a micro-fluid ejection device including a resistive layer deposited adjacent to a substrate and a protective layer deposited adjacent to at least a portion of the resistive layer. The protective layer is tantalum pentoxide.

An advantage of some of the embodiments disclosed herein is the enhanced adhesion between the protective layer and the cavitation layer thereby prolonging the life of a micro-fluid ejection device made with the heater chip. Another advantage of some of the embodiments disclosed herein is the reduction in the number of protective and/or cavitation layers in the heater chip, which provides improved heat transfer from the resistive layer to the fluid thereby reducing power requirements for ejecting fluid from the micro-fluid ejection device. A further advantage can be a reduction in the process steps required to make a micro-fluid ejection device thereby reducing manufacturing costs therefore.

### BRIEF DESCRIPTION OF THE DRAWINGS

Further features and advantages of the disclosed embodiments may become apparent by reference to the detailed description when considered in conjunction with the figures, which are not to scale, wherein like reference numbers indicate like elements through the several views, and wherein:

FIG. 1 is a perspective view, not to scale, of an exemplary device for ejecting fluids from fluid cartridges containing micro-fluid ejection devices;

FIG. 2 is a perspective view, not to scale, of an exemplary fluid cartridge for a micro-fluid ejection device as described in the disclosure;

FIG. 3 is a cross-sectional view, not to scale, of a portion of a prior art micro-fluid ejection device;

FIGS. 4-5 are cross-sectional views, not to scale, of a portion of micro-fluid ejection devices according to an exemplary embodiment of the disclosure; and

FIGS. 6-14 are cross-sectional views, not to scale, of steps for making a heater chip according to an exemplary embodiment of the disclosure.

FIG. 15 is a flow chart of a prior art method for making a heater chip.

FIGS. 16-17 are flow charts of methods for making a heater chip according to an exemplary embodiment of the disclosure.

### DETAILED DESCRIPTION OF THE EXEMPLARY EMBODIMENTS

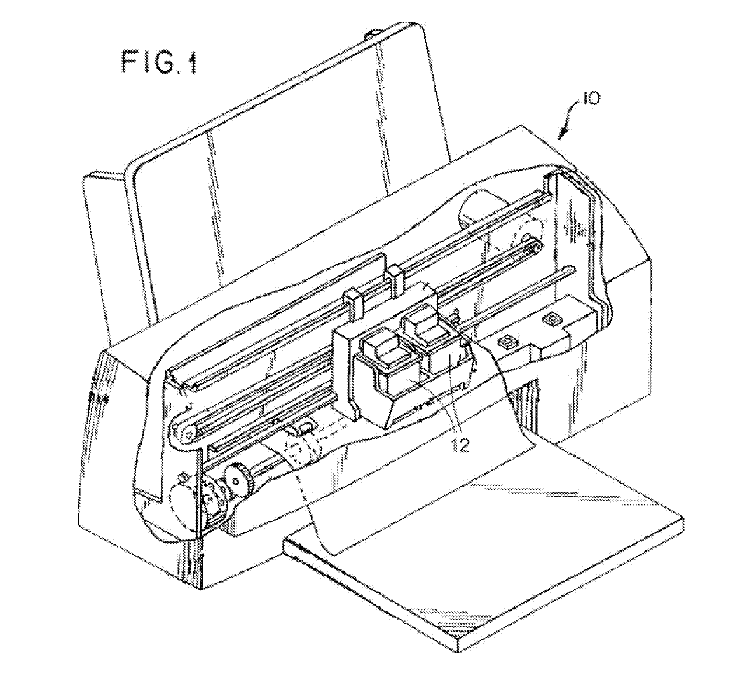

Embodiments as described herein are particularly suitable for micro-fluid ejection devices, for example, the micro-fluid ejection devices described herein may be used in ink jet printers. An ink jet printer 10 is illustrated in FIG. 1 and includes one or more ink jet printer cartridges 12 containing the micro-fluid ejection devices described in more detail below.

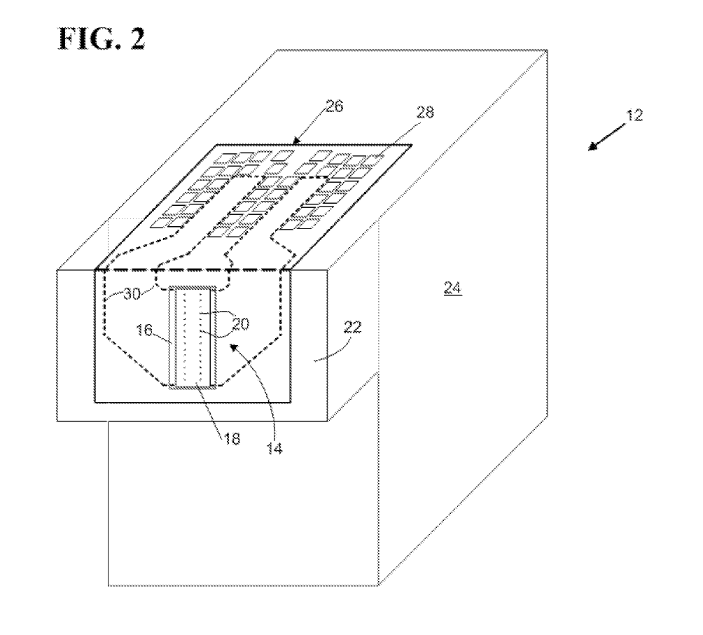

An exemplary ink jet printer cartridge 12 is illustrated in FIG. 2. The cartridge 12 includes a printhead 14, also referred to herein as an example of “a micro-fluid ejection head.” The micro-fluid ejection head 14 includes a substrate 16 and an attached nozzle plate 18 having nozzles 20. The ejection head 14 is attached to an ejection head portion 22 of the cartridge 12. A main body 24 of the cartridge 12 includes a fluid reservoir for supplying a fluid such as ink to the ejection head 14. A flexible circuit, such as tape automated bonding (TAB) circuit 26, containing electrical contacts 28 for connection to the printer 10 is attached to the main body 24 of the cartridge 12. Electrical tracing 30 from the electrical contacts 28 are attached to the substrate 16 to provide activation of electrical devices on the substrate 16 on demand from the printer 10 to which the cartridge 12 is attached. The invention however, is not limited to ink cartridges 12 as described above as the micro-fluid ejection heads 14 described herein may be used in a wide variety of fluid ejection devices, including but not limited to, ink jet printers, micro-fluid coolers, pharmaceutical delivery systems, and the like.

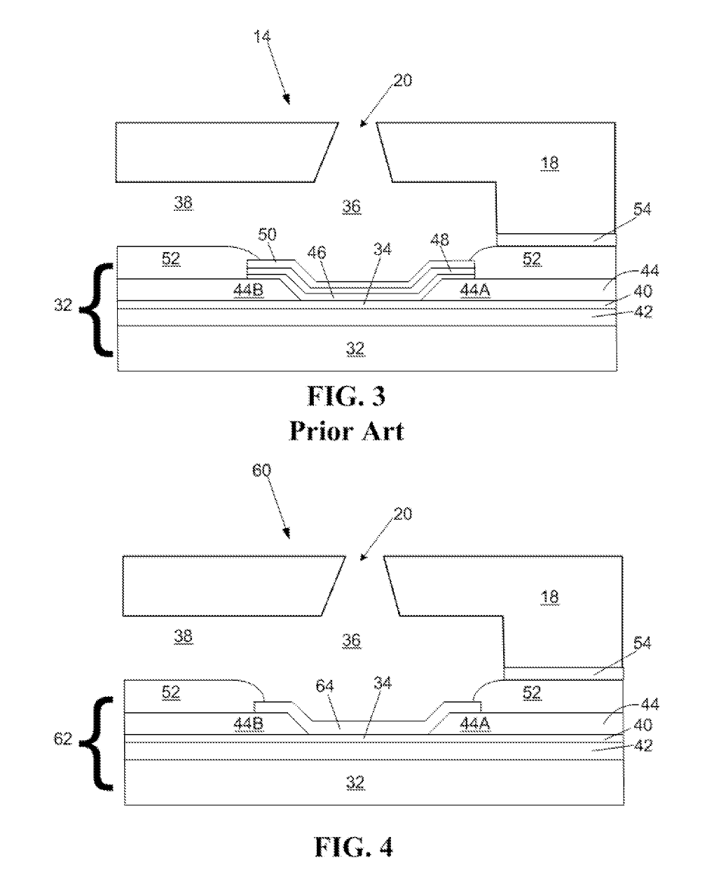

A cross-sectional view of a portion of a prior art micro-fluid ejection head 14 is illustrated in FIG. 3. The micro-fluid ejection head 14 includes a substrate 32 having a fluid ejection actuator provided as by a heater resistor 34 and the nozzle plate 18 attached to the substrate 32. The nozzle plate 18 includes nozzles 20 and may be made from a fluid resistant polymer such as polyimide, or any other fluid resistant material. Fluid is provided adjacent the heater resistor 34 in a fluid chamber 36 from a fluid channel 38 that is in fluid flow communication through an opening or to via in the substrate 32 with the fluid reservoir in the main body 24 of the cartridge 12.

In the prior art device 14 shown in FIG. 3, the heater resistor 34 is deposited as a resistive layer 40 adjacent to an insulating layer or dielectric layer 42. The resistive layer 40 may be selected from TaAl, Ta₂N, TaAl(O,N), TaAlSi, TaSiC, Ti(N,O), WSi(O,N), TaAlN and TaAl/Ta having a thickness ranging from about 500 to about 2000 Angstroms.

A first metal conductive layer 44 selected from gold, aluminum, silver, copper, and the like is deposited on the resistive layer 40 and is etched to form power and ground conductors 44A and 44B thereby defining the heater resistor 34 therebetween. A plurality of passivation and protection layers 46, 48, and 50 are deposited on the heater resistor 34 to provide protection from erosion and corrosion. The first and second protective layer 46 and 48 are typically provided by a composite layer of silicon nitride/silicon carbide materials. A cavitation layer 50 made of tantalum is deposited on layer 48 to provide protection for the underlying layers 40, 46 and 48 from erosion due to bubble collapse and mechanical shock during fluid ejection cycles.

Overlying the conductive layer 44 is another insulating layer or dielectric layer 52 typically composed of epoxy photoresist materials, polyimide materials, silicon nitride, silicon carbide, silicon dioxide, spun-on-glass (SOG), laminated polymer and the like. The insulating layer 52 provides insulation between a second metal conductive layer 54 and the underlying first metal conductive layer 44.

In some prior art ejection heads, a thick polymer film layer is deposited on the second metal conductive layer 54 to define an ink chamber and ink channel therein. In other micro-fluid ejection heads, the thick film layer may be eliminated and the ink channel 36 and ink chamber 38 are formed integral with the nozzle plate 18 in the nozzle plate material as shown in FIG. 3.

One disadvantage of the prior art ejection head 14 described above is that multiple protective layers 46, 48, and 50 are deposited and etched to provide suitable protection for the heater resistor 34 from erosion and corrosion. Such depositing and etching operations require multiple process steps conducted on multiple process tools with movement of the substrate 32 between various process tool stations.

Also, difficulties have been encountered when using tantalum as a cavitation to layer 50 with underlying layers 46 and 48. For example, when the passivation layers 46 and/or 48 are comprised of materials such as diamond-like carbon (DLC), adhesion of the tantalum layer 50 to the DLC layer is unreliable. Furthermore, additional equipment may be required to separately deposit the tantalum layer 50 on the substrate 32. Finally, the multiple layers 48, 48, and 50 having suitable thicknesses required to protect the heater resistor 34 also tend to increase the power requirements required to eject a drop of fluid from the nozzles 20 by increasing a thickness of a heater stack 55 which is a combination of layers 40, 46, 48, and 50. Increased power requirements may be the result of poor thermal conductivity through the multiple layers.

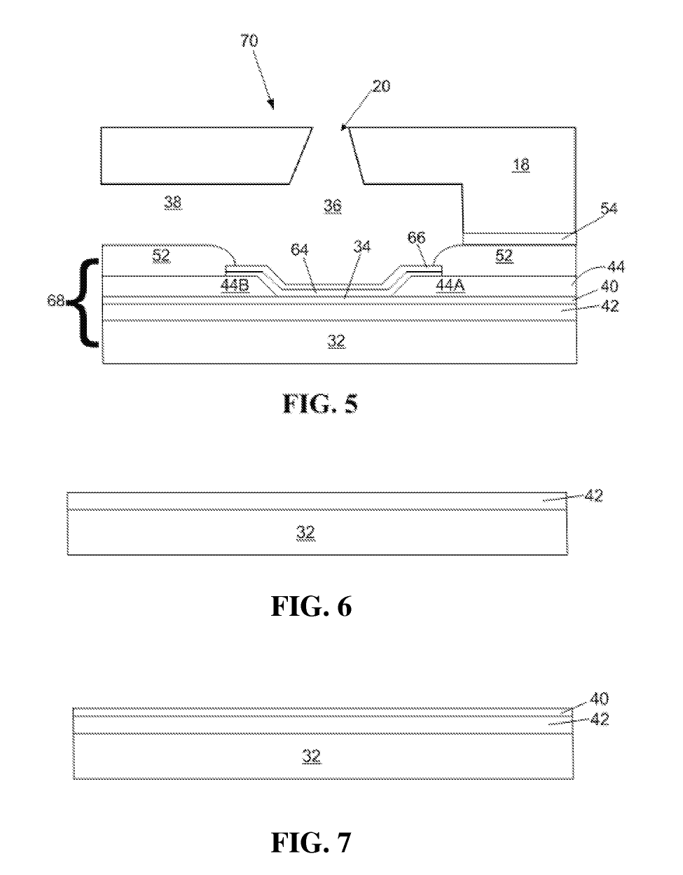

The embodiments described herein improve upon the prior art micro-fluid ejection device design by providing an improved protection layer that may be used with or without a separate cavitation layer. Features of these embodiments will now be described with reference to FIGS. 4-5.

With reference to FIG. 4, there is provided a micro-fluid ejection device 60 having a heater chip 62 and a nozzle plate 18 with the nozzles 20. The heater chip 62 includes a substrate 32 and insulating layer 42 as described above. A resistive layer 40 selected from the group consisting of TaAl, Ta₂N, TaAl(O,N), TaAlSi, TaSiC, Ti(N,O), WSi(O,N), TaAlN, and TaAl/Ta is deposited adjacent to the insulating layer 42. The resistive layer 40 typically has a thickness ranging from about 500 to about 2000 Angstroms. The invention is not limited to any particular resistive layer as a wide variety of materials known to those skilled in the art may be used as the resistive layer 40.

Next, the first metal layer 44 is deposited adjacent to the resistive layer 40 and is etched to define a heater resistor 34 and conductors 44A and 44B as described above. As before, the first metal layer 44 may be selected from conductive metals, including, but not limited to, gold, aluminum, silver, copper, and the like.

A protective layer 64 is then deposited over a portion of the metal layer 44 and portion of the resistive layer 40 defining the heater resistor 34. The protective layer 64 is comprised of a tantalum oxide, for example tantalum pentoxide (Ta₂O₅). The protective layer 64 typically may have a thickness ranging from about 500 to about 8000 Angstroms, usually about 5000 Angstroms. Using tantalum pentoxide as the to protective layer 64 and as the cavitation layer 66, that is, using one layer of tantalum pentoxide to perform the functions of both a protective layer 64 and a cavitation layer 66 may provide additional benefits over the prior art configurations. Such benefits may include reduced heater stack thickness and potentially reduced manufacturing costs as discussed below.

Generally, as the heater stack thickness decreases, energy requirements for ejecting fluids from the micro-fluid ejection heads also decreases. However, using a same thickness of tantalum pentoxide as a thickness of the prior art DLC layer 46/48 may require about 90 nanoseconds more pulse time to achieve vapor bubble nucleation due to the lower thermal conductivity of the tantalum pentoxide layer. In such event, there is about a nine percent increase in heater energy. However, because the dielectric properties of tantalum pentoxide are superior to DLC by about three times, the net effect is a lower ejection energy required because the breakdown increase of tantalum pentoxide is more than the thermal conductivity decrease of tantalum pentoxide compared to DLC. Accordingly, if a 2000 Angstrom layer of tantalum pentoxide is used in place of a 2000 Angstroms layer of DLC, and there is no tantalum cavitation layer on the tantalum pentoxide, a seven percent energy decrease in heater ejection energy is expected.

In an alternative embodiment, shown in FIG. 5, a separate cavitation layer 66 made of tantalum (Ta) may be deposited adjacent to the protective layer 64 described above to provide a heater chip 68 for a micro-fluid ejection device 70. In such an embodiment, the protective layer 64 typically may have a thickness ranging from about 500 to about 6000 Angstroms, usually no more than about 4000 Angstroms, and the cavitation layer 66 may have a thickness ranging from about 1000 to about 6000 Angstroms, usually no more than about 4000 Angstroms.

A tantalum oxide protective layer 64 as described above may significantly improve adhesion between adjacent layers as compared to a DLC layer or a SiN/SiC layer. For example, the adhesion between a cavitation layer 50 (FIG. 3) and a diamond-like carbon (DLC) layer or SiC/SiN layer 46/48 is relatively weak due to the lack of a suitable adhesion mechanism between the layers and the difference in thermal expansion coefficient of the layers. The tantalum oxide protective layer 64 is believed to form a compound interface or diffusion interface between the resistive to layer 40 and the protective/cavitation layer 64/66, particularly when the resistive layer 40 also contains tantalum. Also, in the alternate embodiment of FIG. 5, the adhesion between the tantalum oxide protective layer 64 and the tantalum cavitation layer 66 is much greater than the prior art adhesion between Si-DLC and tantalum because of a chemical bond at the tantalum oxide and tantalum interface Improved adhesion enhances heater stack reliability as poor protective and cavitation adhesion is believed to be the dominant failure mechanisms of heater stacks.

Tantalum oxides, for example tantalum pentoxide, are high-performance dielectric materials with excellent chemical resistance ideal for the protective layer 64. Properties of such protective materials include high breakdown voltage, high mechanical stability and excellent adhesion to many of the materials used as resistive layers 40, particularly materials such as TaAl and TaAlN containing tantalum.

A method for making a heater chip 62, 68 for a micro-fluid ejection device 60, 70 according to the exemplary embodiments disclosed herein is illustrated in FIGS. 6-14. Conventional microelectronic fabrication processes such as physical vapor deposition (PVD), chemical vapor deposition (CVD) and sputtering may be used to provide the various layers on the substrate 32.

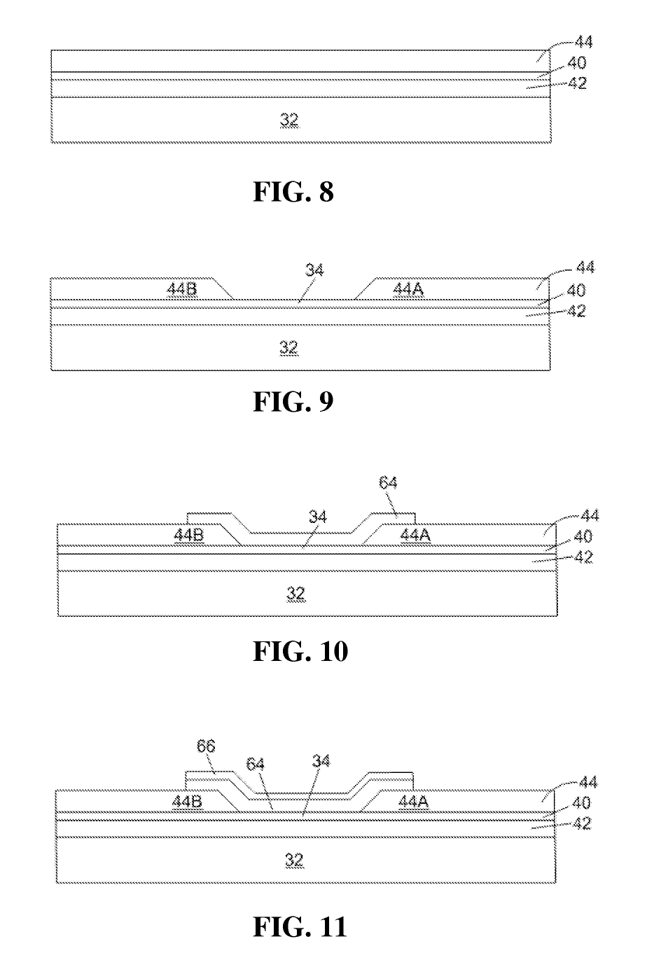

Step one of the process is shown in FIG. 6 wherein an insulating layer 42, which, in some embodiments, is made of silicon dioxide, is formed on the surface of the substrate 32. Next, the resistive layer 40 is deposited by conventional sputtering technology adjacent to the insulating layer 42 as shown in FIG. 7. The resistive layer 40 may be any of the materials described above. The first metal conductive layer 44 is then deposited adjacent to the resistive layer 40 as shown in FIG. 8. The first metal conductive layer 44 is generally etched to provide ground and power conductors 44A and 44B and to define the heater resistor 34 as shown in FIG. 9.

In order to protect the heater resistor 34 from corrosion and erosion, for example, the tantalum oxide protective layer 64 as described above may be deposited adjacent to the heater resistor 34 as shown in FIG. 10. The cavitation layer 66, if used, is then deposited adjacent to the tantalum oxide protective layer 64 as shown in FIG. 11. The tantalum oxide protective layer 64 may be deposited by CVD, plasma enhanced chemical vapor deposition (PECVD), anodization, and reactive-sputtering. As discussed below, use of reactive-sputtering allows the same machine tool to be to used for tantalum deposition, should a cavitation layer 66 be desired. An ability to use the same tool may result in reduced manufacturing costs.

Reactive sputtering involves the use of a tantalum target and an oxygen-containing reactive gas. The target, oxygen-containing reactive gas and substrate 32 having the resistive layer 40 and conductive layer 44 are placed in a sputtering chamber. A pulsed DC power source applies a pulsed DC (direct current) voltage to the target. The pulsed DC voltage may be oscillated between negative and positive states or on and off states. A suitable pulsing frequency may be such that the DC voltage is off for at least about 5% of the time of each pulse cycle which is the total time period of one DC pulse. The DC voltage may be off for less than about 50% of the time of each pulse cycle, and typically for about 30% of the time of each pulse cycle. For example, for a total individual pulse cycle time of 10 microseconds, the pulsed DC voltage may be maintained “on” for about 7 microseconds and “off” for about 3 microseconds. The pulsed DC voltage may be pulsed at a pulsing frequency of at least about 50 kHz, and typically less than about 300 kHz. A suitable DC voltage level is from about 200 to about 800 Volts. Elemental material sputtered from the target combines with a reactive species in the chamber to form a film of tantalum oxide adjacent to the resistive layer 40 and conductive layer 44. A suitable reactive sputtering process for forming the tantalum oxide layer 64 is described in more detail, for example, in U.S. Pat. No. 6,946,408 to Le, et al., the disclosure of which is incorporated herein by reference.

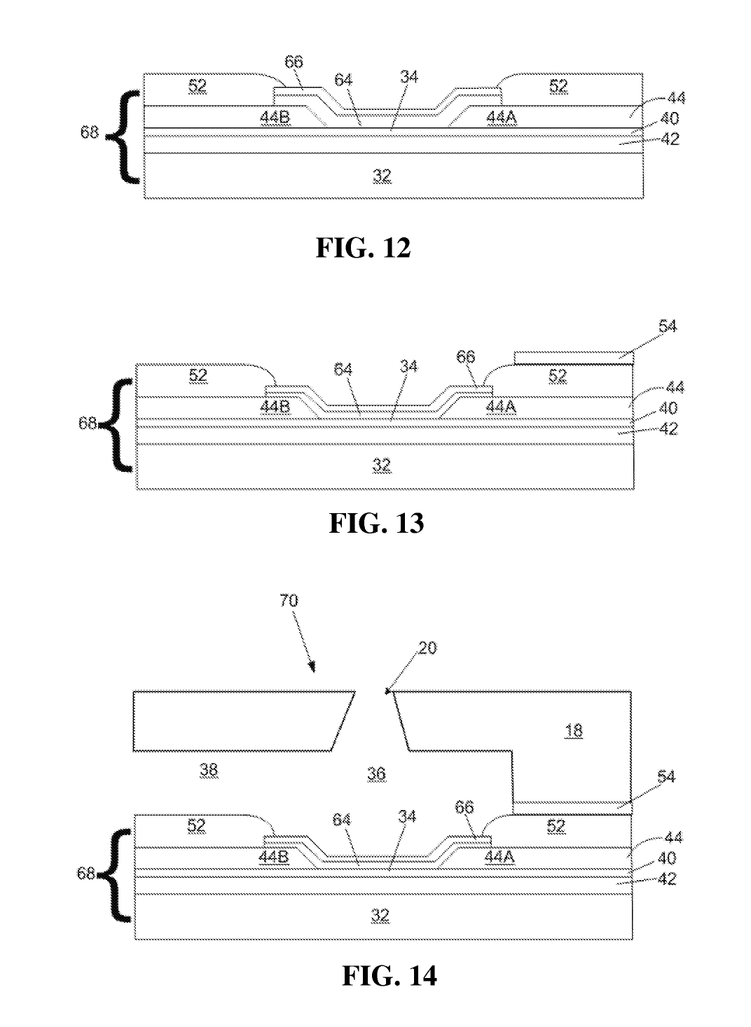

After depositing the protective layer(s) 64 and/or 66, a second dielectric layer or insulating layer 52 is deposited adjacent to exposed portions of the first metal layer 44 and in some embodiments slightly overlaps the tantalum oxide protective layer 64 and optional cavitation layer 66 as shown in FIG. 12. The second metal conductive layer 54 is then deposited adjacent to the second insulating layer 52 as shown in FIG. 13 and is in electrical contact with conductor 44A through a via in the insulating layer 52. Finally, the nozzle plate 18 may be attached, such as by an adhesive, to the heater chip 68 as shown in FIG. 14 to provide the micro-fluid ejection device 70.

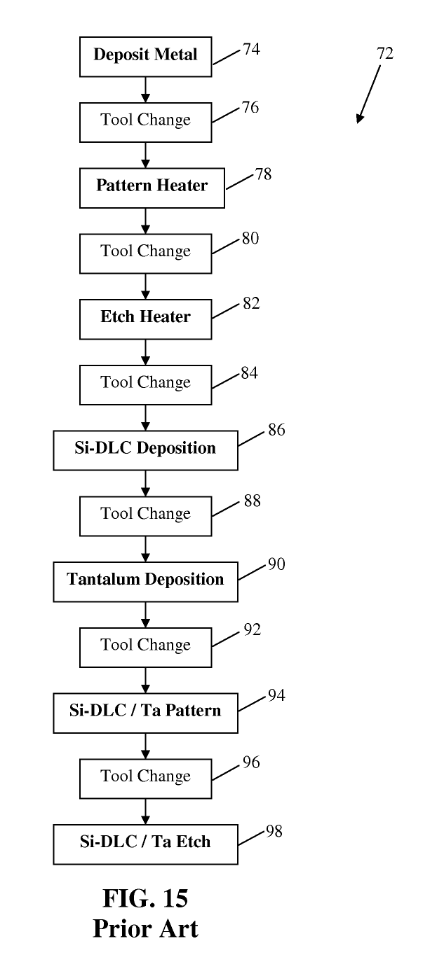

Referring now to FIG. 15, a flow diagram for a portion of a prior art process 72 for making a heater chip for a micro-fluid ejection device is shown. In the first step 74 of the process 72, a metal layer is deposited on a resistive layer. Next, the to first of several tool changes, indicated by step 76, must be performed. The metal layer is then patterned in step 78 to define an area for the heater resistor followed by another tool change in step 80. Etching of the metal layer to define the heater resistor is conducted in step 82, and another tool change takes place in step 84. Next, a protective layer, for example DLC is deposited in step 86 and another tool change is performed in step 88. Then, a tantalum cavitation layer is deposited in step 90, and a tool change is performed in step 92. In step 94, the DLC and the tantalum layers are patterned, and the last tool change 96 is performed. Finally, the DLC and the tantalum layers are etched in step 98.

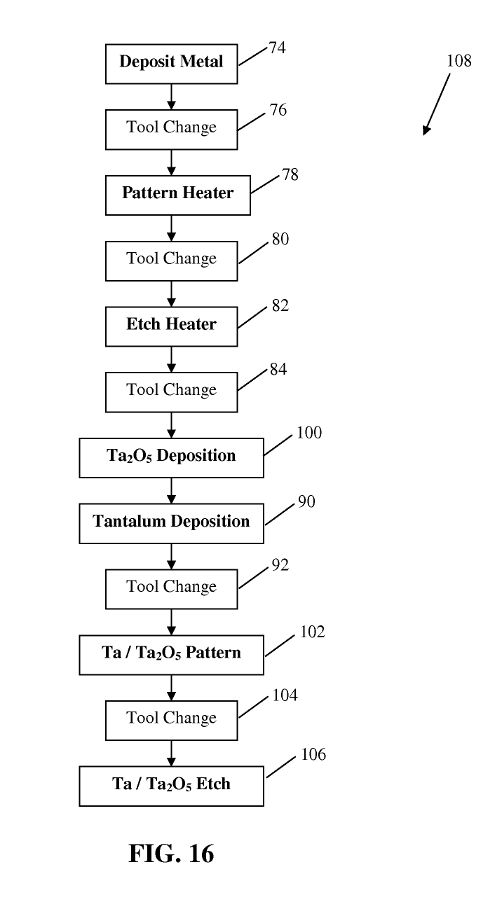

The prior art process 72 illustrated in FIG. 15 may be improved as shown in FIG. 16 by using tantalum pentoxide instead of DLC for the protective layer on the heater resistor as discussed above. In the process 108 shown in FIG. 16, for example, the tool change step 88 (FIG. 16) is unnecessary between a step 100 of depositing the tantalum pentoxide and the step 90 for depositing the tantalum cavitation layer. Patterning the tantalum pentoxide and tantalum layers is conducted in step 102 followed by a tool change in step 104 and etching in step 106 to provide the heater chip 70. Thus, according to the process 108 shown in FIG. 16, five tool changes 76, 80, 84, 92, and 104 occur, whereas the prior art process 72 shown in FIG. 15 requires six tool changes 76, 80, 84, 88, 92, and 96.

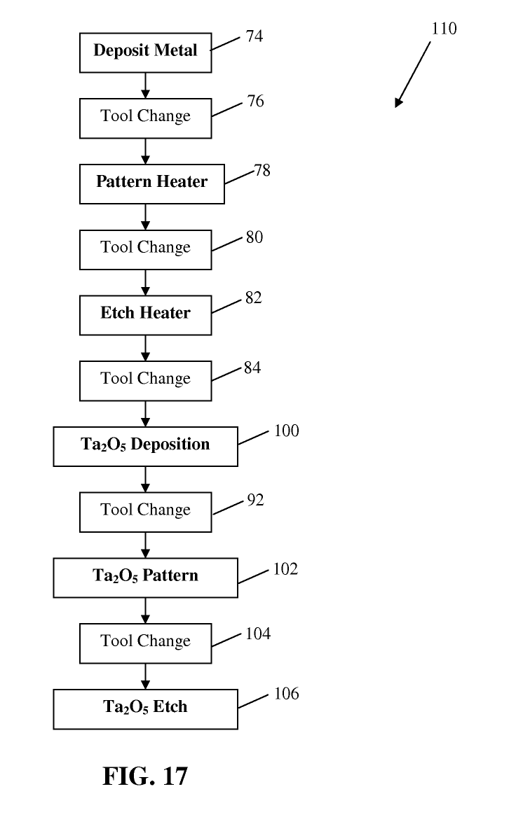

Referring now to FIG. 17, an alternate embodiment where tantalum pentoxide has a dual function as a protective layer and a cavitation layer, as described above with reference to FIG. 4, is shown. Process 110 further improves efficiency over process 108 because, for example, the tantalum deposition step 90 (FIGS. 15 and 16) is not used. Accordingly, process 110 has one less step than process 108 and two fewer steps than process 72.

The foregoing description of exemplary embodiments of the disclosure has been presented for purposes of illustration and description. The exemplary embodiments are not intended to be exhaustive or to limit the disclosed embodiments to the precise form disclosed. Obvious modifications or variations are possible in light of the above disclosure. The embodiments are chosen and described in an effort to provide the best illustrations of the principles of the disclosed embodiments and their practical application, and to thereby enable one of ordinary skill in the art to to utilize the disclosed embodiments with various modifications as are suited to the particular use contemplated. All such modifications and variations are within the scope of the disclosed embodiments as determined by the appended claims when interpreted in accordance with the breadth to which they are fairly, legally, and equitably entitled.

What is claimed is:

1. A micro-fluid ejection device comprising a heater chip including:
a substrate;
a resistive layer on the substrate;
a conductor layer on the resistor layer, including a power and ground pair of electrodes defining a surface spacing on the resistive layer; and
a dual purpose cavitation and protective layer directly on a surface portion of the resistive layer filling the surface spacing between the power and ground pair of electrodes, wherein the cavitation and protective layer comprises tantalum oxide and no other layer exists above the cavitation and protective layer adjacent the surface portion of the resistive layer so fluid bubbles can directly cavitate against the cavitation and protective layer during fluid ejection cycles.

2. The micro-fluid ejection device of claim 1, wherein the cavitation and protective layer has a thickness ranging from about 500 to about 8000 Angstroms.

3. The micro-fluid ejection device of claim 1, wherein the cavitation and protective layer essentially comprises tantalum pentoxide.

4. The micro-fluid ejection device of claim 1, wherein the resistive layer comprises a material selected from the group consisting of TaAl, Ta₂N, TaAl(O,N), TaAlSi, TaSiC, Ti(N,O), WSi(O,N), TaAlN, and TaAl/Ta.

5. The micro-fluid ejection device of claim 1, having an energy requirement for ejecting fluid droplets of from about 0.10 to less than about 0.25 microjoules per nanogram of fluid.

6. A heater chip for a micro-fluid ejection device, comprising:
a substrate;
a resistive layer on the substrate;
a conductor layer directly on the resistor layer, including an anode and cathode pair of electrodes; and
a single layer directly on a surface portion of the resistive layer between the anode and cathode, wherein the single layer provides both protection and cavitation functions to the resistive layer at the surface portion and comprises tantalum pentoxide (Ta₂O₅), no other layer exists above the single layer adjacent the surface portion of the resistive layer so fluid bubbles can directly cavitate against an outer surface of the single layer during fluid ejection cycles.

7. The heater chip of claim 6, wherein the single layer has a thickness ranging from about 500 to about 8000 Angstroms.

8. The heater chip of claim 6, wherein the resistive layer comprises a material selected from the group consisting of TaAl, Ta₂N, TaAl(O,N), TaAlSi, TaSiC, Ti(N,O), WSi(O,N), TaAlN, and TaAl/Ta.

9. The heater chip of claim 6, having an energy requirement for ejecting fluid droplets of from about 0.10 to less than about 0.25 microjoules per nanogram of fluid.

10. The heater chip of claim 6, wherein the single layer has a thickness of about 2000 Angstroms.

11. The heater chip of claim 6, wherein the single layer has a thickness of about 5000 Angstroms.

12. The heater chip of claim 6, wherein the single layer further directly contacts etched portions of the anode and cathode of the conductor layer.
